(19) United States
(12) Patent Application Publication
(10) Pub. No.: US 2009/0298328 A1
(43) Pub. Date: Dec. 3, 2009

(54) PLUG WITH DISPLACED CIRCUIT AND CONNECTING MODULE USING THE SAME

(76) Inventors: CHIEN-CHUN WANG, Taoyuan County (TW); Chin-Fan Wu, Taoyuan County (TW)

Correspondence Address: Chien-Hui Su, P. O. Box 70-121 Taichung, Taichung City, 40899, TW

(21) Appl. No.: 12/209,192

(22) Filed: Sep. 11, 2008

(30) Foreign Application Priority Data
May 30, 2008 (TW) 097120417

(51) Int. Cl. H01R 31/08

(52) U.S. Cl. 439/507

(57) ABSTRACT

A connecting module includes a flat cable, a connecting interface electrically connected to one end of the flat cable, a socket electrically mounted on the connecting interface and a plug partially and detachably inserted into the socket. The plug has two opposite sides respectively having a third conductive section and a fourth conductive section disposed thereon. The third conductive section and the fourth conductive section electrically connected to each other via a displacement circuit that is disposed in the plug such that correspondences between the third conductive section and the fourth conductive section are displaced for providing a jumper function when being inserted into the socket.

### BACKGROUND OF THE INVENTION

1. Field of the Invention

The present invention relates to a connecting module, and more particularly to a connecting module that has a plug with a displacement circuit inserted into the connecting module for used as jumper(s).

2. Description of Related Art

As well known, connectors are used as a medium for relatively transmitting signal between/among electric equipments. A conventional connector has two joints disposed to two opposite ends thereof or has one end electrically connected to a circuit board and the other end having a joint mounted thereon relative to the operational condition. However, some conventional connectors need to have a structure providing a function as jumper(s).

Conventional connecting devices usually include a flat cable electrically connected to a connector in which a series of lead pins is disposed. Each lead pin protrudes out of the connector to form a connecting end. However, the series of lead pins simply provides a function of transmitting signal without concerning a function as jumpers. Consequently, the some wires in the flat cable need to be displaced when the connecting device needs to use jumpers for being suitable to different interfaces.

As a result, the previously displaced flat cable is only provided to connect unique electric equipment such that the user needs to prepare multiple connecting devices with different displaced flat cable for various electric equipments. Consequently, the use scope of the conventional connecting device is limited. In addition, the bad rate of manufacturing the conventional connecting device is raised. The conventional connecting device without jumper function needs to be advantageously altered.

The present invention has arisen to mitigate and/or obviate the disadvantages of the conventional connecting device that has no function concerning jumper.

### SUMMARY OF THE INVENTION

The main objective of the present invention is to provide an improved connecting module that provides a function as jumper(s).

To achieve the objective, the connecting module in accordance with the present invention comprises a flat cable having a first end on which an electric conductive section is disposed and a second end adapted to be connected to a display interface. A connecting interface is electrically connected to the electric conductive section of the flat cable. The connecting interface includes an initial conductive section and a terminal conductive section respectively disposed thereon, wherein the initial conductive section is electrically connected to the electric conductive section and insulated from the terminal conductive section. A socket is electrically mounted on the connecting interface. The socket includes a first conductive section and a second conduct section respectively disposed thereon, wherein the first conductive section is electrically connected to the initial conductive section and the second conductive section is electrically connected to the terminal conductive section. The socket includes a slot longitudinally defined therein. A plug is inserted into the slot in the socket. The plug includes a third conductive section and a fourth conductive section respectively disposed thereon and electrically connected to each other via a displacement circuit that is disposed in the plug such that the correspondences between the third conductive section and the fourth conductive section are displaced for providing a function as jumper(s). The third conductive section and the fourth conductive section are respectively electrically connected to the first conductive section and the second conductive section such that the electric conductive section is electrically with the terminal conductive section when the plug is inserted into the socket. Consequently, the connecting module can be suitable to various electric interfaces by changing the plugs on which different displacement circuits are disposed.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a connecting module in accordance with the present invention;

FIG. 1A is a perspective view of a plug of the connecting module of the present invention in another direction;

FIG. 1B is a perspective view of a socket of the connecting module of the present invention in another direction;

FIG. 2 is a partially exploded perspective view of the connecting module in accordance with the present invention;

FIG. 3 is a perspective view of the connecting module in accordance with the present invention; and

FIG. 4 is another perspective view of the connecting module in accordance with the present invention.

### DETAILED DESCRIPTION OF THE INVENTION

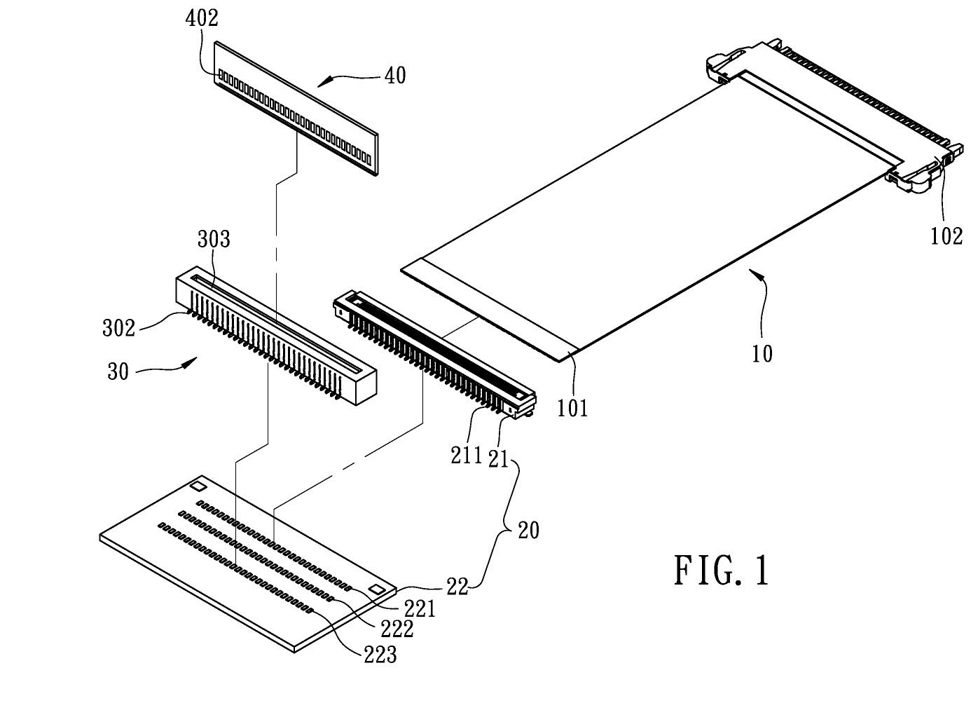

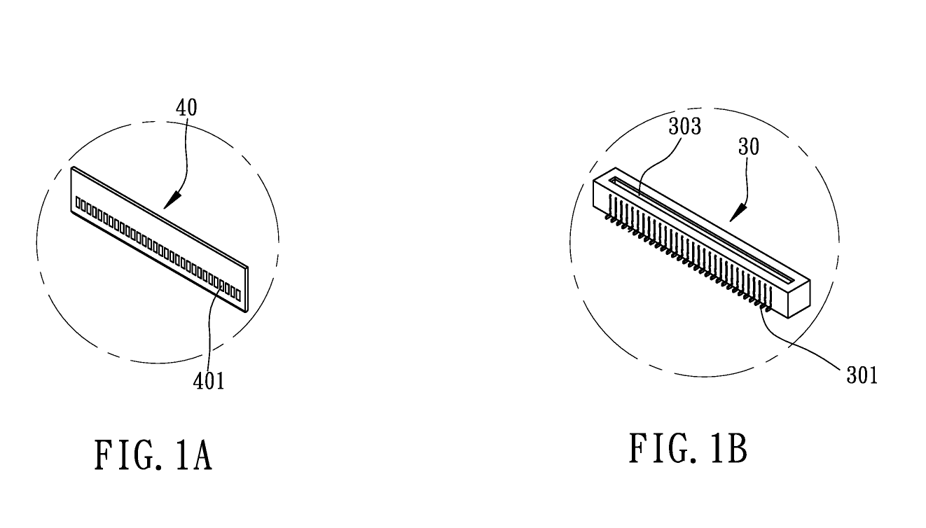

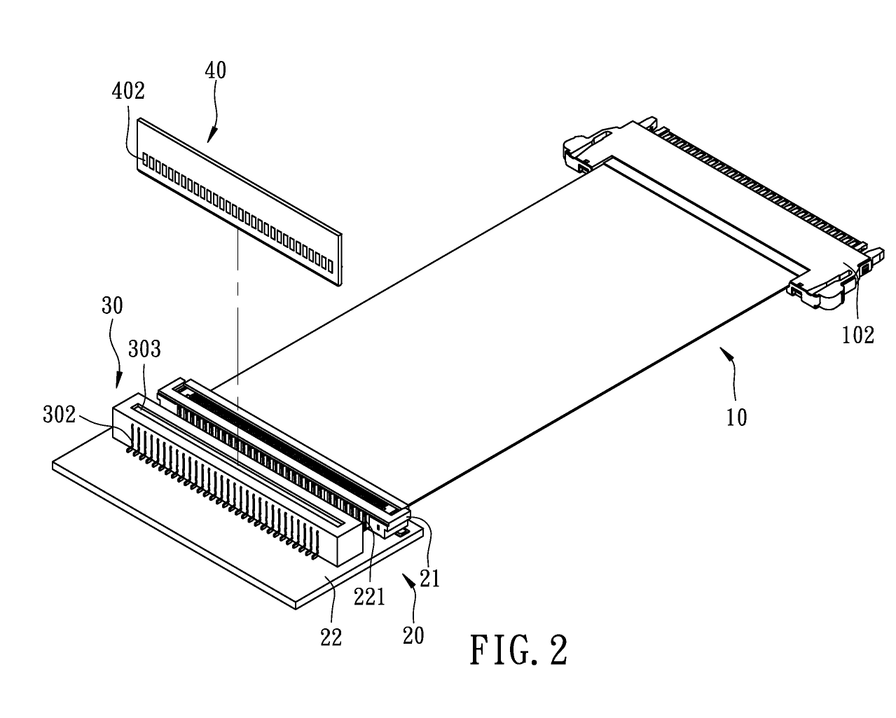

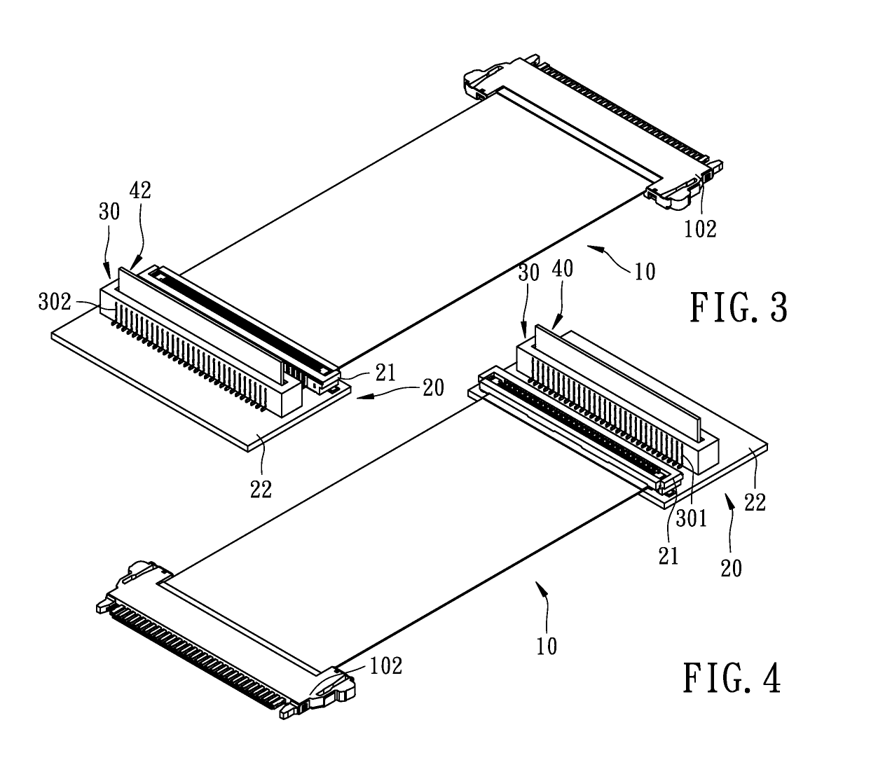

Referring to the drawings and initially to FIGS. 1-4, a connecting module in accordance with the present invention comprises a flat cable (10), a connecting interface (20) electrically connected to one end of the flat cable (10), a socket (30) electrically mounted on the connecting interface (20) and a plug (40) partially and detachably inserted into the socket (30) for providing function as jumper(s).

In the preference embodiment of the present invention, the flat cable (10) is a flexible flat cable (FFC). The flat cable (10) has a first end disposed with an electric conductive section (101) for electrically connected to the connecting interface (20) and a second end connected to an accessory insert board (102). In the preferred embodiment of the present invention, the accessory insert board (102) is provided for low-voltage differential signaling (LVDS) and serving as a signal transmission interface of a display interface.

The connecting interface (20) includes a connecting element (21) electrically connected to the electric conductive section (101) and a system board interface (22), wherein the connecting element (21) is electrically disposed on the system board interface (22). A conductive section (221), an initial conductive section (222) and a terminal conductive section (223) are respectively disposed on the system board interface (22). As shown in FIG. 1, the conductive section (221), the initial conductive section (222) and the terminal conductive section (223) are parallel to one another. The connecting element (21) has a conductive section (211) disposed thereon, wherein the conductive section (211) on the connecting element (21) is electrically connected with conductive section (221) on the system board interface (22). The conductive section (221) on the system board interface (22) is electrically connected with the initial conductive section (222) that is insulated from the terminal conductive section (223), and the terminal conductive section (223) is electrically connected with a control circuit (not shown) that is disposed on the system board interface (22).

The socket (30) includes two opposite sides respectively having a first conductive section (301) and a second conductive section (302) disposed thereon, wherein the first conductive section (301) and the second conductive section (302) are insulated from each other. The first conductive section (301) and the second conductive section (302) are respectively electrically connected with the initial conductive section (222) and the terminal conductive section (223). The socket (30) has a slot (303) longitudinally defined in the socket (30) between the first conductive section (301) and the second conductive section (302).

The plug (40) is double-sided looped. The plug (40) includes two opposite sides respectively having a third conductive section (401) and a fourth conductive section (402) disposed thereon. The third conductive section (401) and fourth conductive section (402) are electrically connected with each other via a circuit in the plug (40). In addition, the correspondences between the third conductive section (401) and the fourth conductive section (402) are displaced due to a displacement circuit (not shown) that is disposed on the plug (40) for providing a function as jumper(s). Consequently, the electric conductive section (101) is electrically connected to the terminal conductive section (223) sequentially via the connecting element (21), the system board interface (22), the socket (30) and the plug (40). In addition, the plug (40) provides a function as jumper(s) due to the displaced circuit on the plug (40). Consequently, different plug (40) provides different jumper function to the connecting module in accordance with the present invention. Consequently, the connecting module in accordance with the present invention is suitable to connected with various electric equipments by changing the plug (40) that has different displaced circuit disposed thereon for provides various jumper function.

Although the invention has been explained in relation to its preferred embodiment, it is to be understood that many other possible modifications and variations can be made without departing from the spirit and scope of the invention as hereinafter claimed.

What is claimed is:

1. A looped plug with displaced circuit, comprising two opposite sides respectively having a first conductive section and a second conductive section disposed thereon, the first conductive section and the second conductive section electrically connected to each other via a displacement circuit that is disposed in the plug such that correspondences between the first conductive section and the second conductive section are displaced for providing a jumper function when being inserted into a connecting module.

2. A connecting module, comprising:
a connecting interface comprising an initial conductive section and a terminal conductive section respectively disposed thereon, wherein the initial conductive section is insulated from the terminal conductive section;
a socket electrically mounted on the connecting interface, the socket comprising a first conductive section and a second conduct section insulated from the first conductive section respectively disposed thereon, wherein the first conductive section is electrically connected to the initial conductive section and the second conductive section is electrically connected to the terminal conductive section, the socket comprising a slot therein; and
a plug detachably inserted into the slot in the socket, the plug comprising a third conductive section and a fourth conductive section respectively disposed thereon and electrically connected to each other via a circuit that is disposed in the plug, wherein the circuit can displace the correspondences between the third conductive section and the fourth conductive section to perform a function as jumper(s), the third conductive section and the fourth conductive section respectively electrically connected to the first conductive section and the second conductive section such that the initial conductive section is electrically connected to the terminal conductive section when the plug is inserted into the socket.

3. The connecting module as claimed in claim 2, further comprising a flat cable having a first end on which an electric conductive section is disposed and a second end adapted to be connected to a display interface, wherein the electric conductive section of the flat cable is electrically connected to the connecting interface.

4. The connecting module as claimed in claim 3, wherein the electric conductive section of the flat cable is electrically connected to the initial conductive section.

5. The connecting module as claimed in claim 3, wherein the connecting interface comprises a connecting element electrically connected to the electric conductive section and a system board interface, the connecting element having a first conductive portion disposed thereon, a second conductive portion disposed on the system board interface and electrically connected to the first conductive portion on the connecting element, the initial conductive section and the terminal conductive section respectively disposed on the system board interface and the initial conductive section electrically connected to the second conductive portion on the system board interface.

6. The connecting module as claimed in claim 5, wherein the connecting element is electrically disposed on the system board interface.

7. The connecting module as claimed in claim 2, wherein the first conductive section and the second conductive section are respectively disposed on two opposite sides of the socket, and the slot is longitudinally defined in the socket between the first conductive section and the second conductive section.

8. The connecting module as claimed in claim 2, wherein the plug is double-sided, and the third conductive section and the fourth conductive section are respectively disposed on two opposite sides of the plug.

9. The connecting module as claimed in claim 3, further comprising a low-voltage differential signaling connector which is disposed in the flat cable.

10. The connecting module as claimed in claim 3, wherein the flat cable is a flexible flat cable (FFC).

11. The connecting module as claimed in claim 2, further comprising a displacement plug with a displacement circuit whose layout is different from the circuit of the plug, wherein a function as jumper(s) is performed by replacing the plug with the displacement plug.
